(19) United States
(12) Patent Application Publication
(10) Pub. No.: US 2010/0274988 A1
(43) Pub. Date: Oct. 28, 2010

(54) Flexible vector modes of operation for SIMD processor

(76) Inventor: Tibet Mimar, Sunnyvale, CA (US)

Correspondence Address: Sawyer Law Group, P.C., P.O. Box 51418, Palo Alto, CA, 94303, US

(21) Appl. No.: 10/357,632

(22) Filed: Feb. 3, 2003

Related U.S. Application Data
(60) Provisional application No. 60/354,449, filed on Feb. 4, 2002.
(60) Provisional application No. 60/364,315, filed on Mar. 14, 2002.

(51) Int. Cl. G06F 9/30

(52) U.S. Cl. 712/5; 712/4; 712/E09.023

(57) ABSTRACT

In addition to the usual modes of SIMD processor operation, where corresponding elements of two source vector registers are used as input pairs to be operated upon by the execution unit, or where one element of a source vector register is broadcast for use across the elements of another source vector register, the new system provides several other modes of operation for the elements of one or two source vector registers. Improving upon the time-costly moving of elements for an operation such as DCT, the present invention defines a more general set of modes of vector operations. In one embodiment, these new modes of operation use a third vector register to define how each element of one or both source vector registers are mapped, in order to pair these mapped elements as inputs to a vector execution unit. Furthermore, the decision to write an individual vector element result to a destination vector register, for each individual element produced by the vector execution unit, may be selectively disabled, enabled, or made to depend upon a selectable condition flag or a mask bit.

### BACKGROUND OF THE INVENTION

1. Field of the Invention

The invention relates generally to the field of processor chips and specifically to the field of single-instruction multiple-data (SIMD) processors. More particularly, the present invention relates to performance and efficiency of SIMD vector operations.

2. Description of the Background Art

Today, most SIMD processors in embedded or computer systems provide a 64-bit or 128-wide data path architecture. This data path allows operations in 8-bit byte, 16-bit, and 32-bit fixed point and floating-point elements. For example, a 128-bit wide data path could be used to perform eight 16-bit SIMD operations during the time interval of one processor clock cycle.

Prior Art FIG. 1 illustrates that operation occurs between corresponding elements of two vector registers (Element-to-Element Mode), or between one element of a vector register that is broadcast across all elements of another vector register (One-Element Broadcast Mode). A variety of powerful inter-element arithmetic operations usually include: addition, subtraction, and multiply-accumulate. Similarly, logical operations are also supported: AND, OR, NOT, XOR, AND-NOT.

The vector data is loaded from memory into a vector register without shuffling the order of elements. If the placement of data elements does not match what is required, then the vector data is loaded in smaller pieces to compose the sequence of elements in desired order. For example, implementing an 8-length Discrete Cosine Transform (DCT) as required by all common video compression standards requires an operation across different elements. In a single-issue processor, a processor that executes only one instruction as a time, this requires many additional register loads, thus leaving the multiple computational units idle, and slowing the processing time significantly. In a dual-issue processor, a processor that is executing one scalar and one vector instruction, where the scalar unit is used to load and store vector registers, this causes an imbalance where the load operations cannot be “hidden”, i.e., performed concurrently in the background, while vector operations are performed. This is because each vector operation requires several load operations

One of the reasons today's SIMD processors are limited to vector elements of eight is that making wider vectors, such as 16, 32, or 64 elements, further increases the quantity of load operations necessary to compose the data for certain operations such as DCT, thus no speed advantage is gained.

### SUMMARY OF THE INVENTION

The present invention provides a method by which any element of a source-1 vector register may operate as paired with any element of a source-2 vector register. This provides the ultimate flexibility in pairing vector elements as inputs to each of the arithmetic or logical operation units of a processor, such as a SIMD processor. The selection of input elements is controlled by a third vector source register, which we refer to as the control vector register. Certain bit-field within each element of the control vector register associates and selects a source vector element for each source vector as the input element to a computing element of a vector execution unit; that computing element of the vector execution unit corresponds to the particular element of the control vector register, and, that computing element of the vector execution unit corresponds to a particular element of the destination vector register. Other bit-fields within the control vector register define whether a corresponding element position is masked, i.e., whether the result of the vector execution unit operation for that element position is written, depending upon a selected condition code, or not written to the destination vector register. Furthermore, another field of designated bits in control vector register can select a particular operation for that element from a list of operations such as add, subtract, etc. for each vector element position.

### BRIEF DESCRIPTION OF THE DRAWINGS

The accompanying drawings, which are incorporated and form a part of this specification, illustrate prior art and embodiments of the invention, and together with the description, serve to explain the principles of the invention:

Prior Art FIG. 1 illustrates an example of one-to-one and broadcast modes of vector operations, that is, operations between vector elements as implemented by a prior art SIMD processor. Both, one-to-one operations between corresponding vector elements of the source vector registers, and, operations where one element of a source vector register is broadcast to operate in combination across all the elements of the other source vector register, are illustrated in this figure.

FIG. 2 shows elements of two source vector registers being paired for vector operations under the control of third source vector register elements, and also vector operations being controlled optionally.

FIG. 3 shows block diagram of the present invention.

FIG. 4 illustrates details of the select logic.

FIG. 5 illustrates per-vector-element Condition Code and Mask Control of SIMD Operations, that is, the operation of enable/disable bit control and condition code control of vector operations. The symbol “˜” in front of the mask signal indicates that disable bit is inverted before AND operation with the condition codes.

FIG. 6 shows an example of DCT implementation.

### DETAILED DESCRIPTION

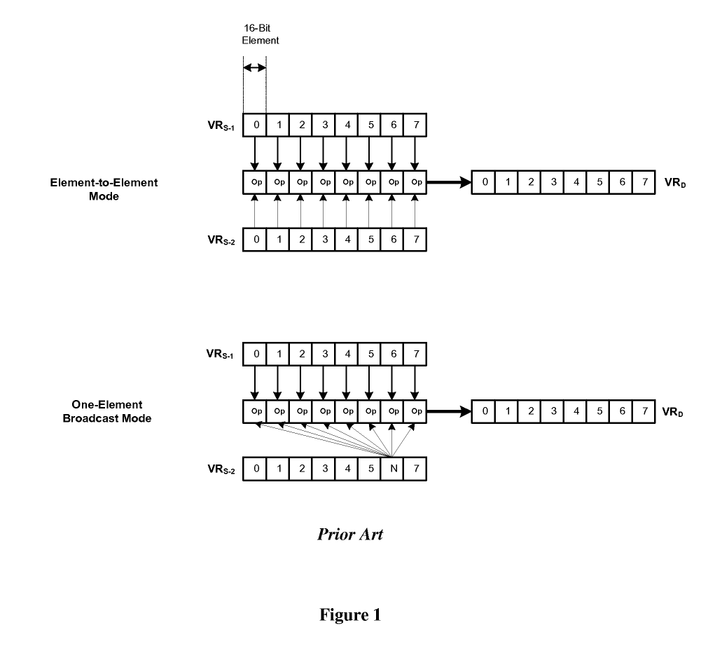

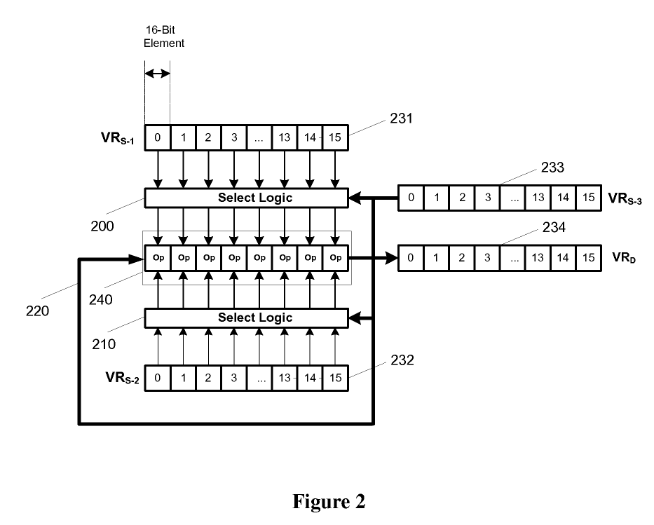

The present invention provides an efficient way to pair any of first source vector elements, VRs-1 231, with any element of a second source vector element, VRs-2 232 for vector operations such as vector-add. vector-multiply, vector-multiply-accumulate, under the control of a third source vector element, VRs-3 233 for vector operations 240 (shown as “Op” for each vector element position), as shown in FIG. 2. Control source vector elements of VRs-3 233 could also choose a different operation for each vector element position. Select logic 200 will select vector elements of VRs-1, and select logic 210 will select vector elements of VRs-2 for pairing, the selected pairs of source vector elements as inputs to inputs of vector operation unit 240. The result of the vector operation is stored in destination vector register VRd 234 in accordance to a mask bit and selected condition flag(s).

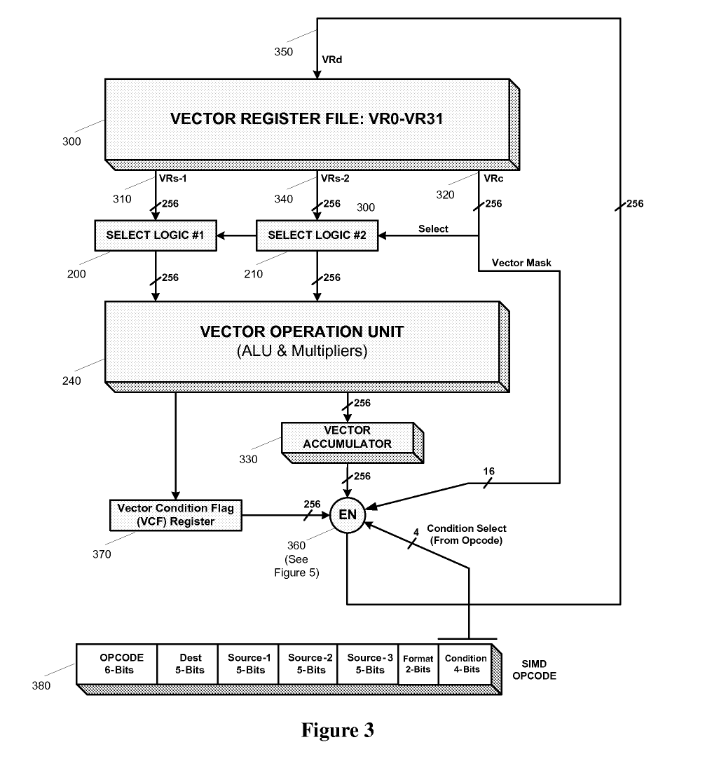

Vector registers, source vector registers VSs-1, VRs-2, VRs-3 and destination vector register VRd are part of the same vector register file 300 in preferred embodiment, as shown in FIG. 3: The vector register file of preferred embodiment has at least three read ports and at least one write port. Source vectors VRs-1 and VRs-2 are read from read ports 310 and 340, and control vector is read from another read port 320. The control paths are not shown, but read and write port addresses of the vector register file are provided by 5-bit source (Source-1-3) and destination fields (Dest) of the opcode 380. The select logic 200 and 210 maps elements of first and second source vector elements. The vector operation unit 240 performs operation selected by the vector instruction, or optionally a different operation for each vector element position. The results of the vector operation unit is passed onto vector accumulator 330, which either passes the results to enable logic (EN) 360, or accumulates and passes the result to enable logic. The output of vector accumulator is written to destination vector register via write port 350, if enable (EN) logic 360 enables the write operation based on mask bit and also selected condition flag bit from VCF register 370 under the control of condition select bit from opcode.

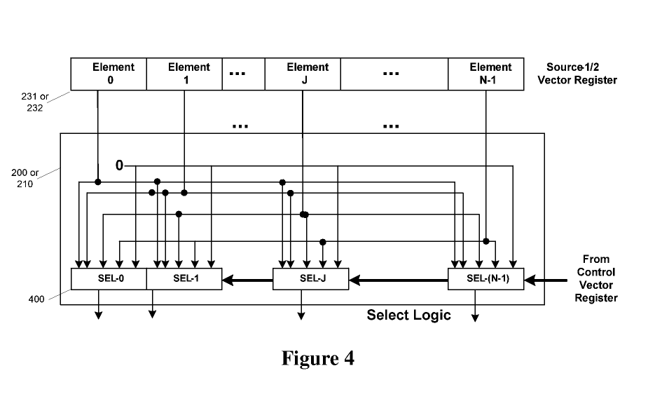

FIG. 4 shows details of the select logic 200 and 210. The select logic for each element position 400 is controlled by designated bit field of control source vector register 233 corresponding to the respective element. Each select logic for a given vector element could select any one of the input source vector elements or a value of zero. Thus, select logic units 200 and 210 constitute means for selecting and pairing any element of first input vector register with any element of second input vector register as inputs to operators for each vector element position in dependence on control register values for respective vector elements. The present invention could also be used for a one-source vector case, where source vector 231 is mapped based on control vector register 233 using select logic 200, and results of execution unit 240 are written to destination vector register 234, if the mask bit is not set for a given element. This is useful for unary operations, such as a negation operation, where operations on certain elements are to be disabled, and leaving corresponding output vector elements unchanged. This is also useful for combining an element re-ordering step with other operations.

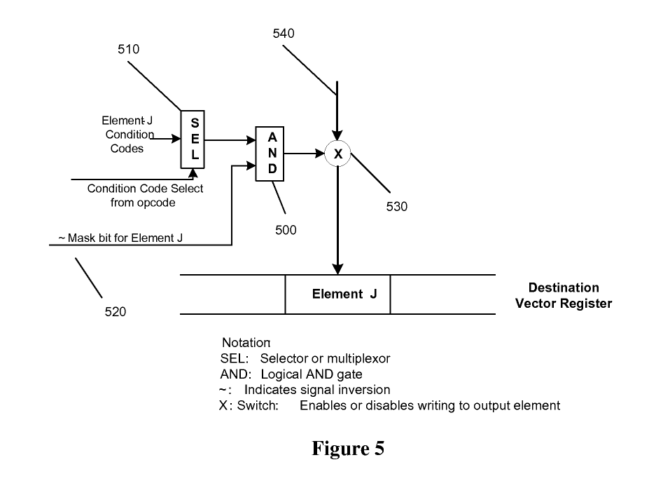

FIG. 5 shows the operation of enable logic 360 with regard to condition flags and mask bit. The data input 540 of enable logic comes from vector accumulator. The condition bits in accordance to condition-select field of opcode, and the same condition-select bits is used for all vector elements. The mask bit 520 is from control vector register element fields. The selector 510 chooses one or combination of condition code flags for each element position from a vector condition flag (VCF) register. The result of the condition code selector is a binary true or false, which is logically AND'ed-500 with the inverted mask (disable) bit. If the result of this is logical zero, then the write-back for that element position is disabled by X switch 530, which leaves the output element for that element position unchanged.

In one preferred embodiment, each vector element is 16-bits and there are 16 elements in each vector. Thus each 16-bit field of control vector register contains 5-bit information to select one of the 16 vector elements as input for each source vector register, and a 1-bit field to mask the operation. The vector control register bits use 11 of the 16 available bits.

There are three vector processor instruction formats in general, although this may not apply to every instruction. These are:

### <Vector Instruction>.<CC> VRd, VRs-1, VRs-2

<Vector Instruction>.<CC> VRd, VRs-1, VRs-2 [element]

### <Vector Instruction>.<CC> VRd, VRs-1, VRs-2, VRs-3

The first form uses operations by pairing respective elements of VRs-1 and VRs-2. This form eliminates the overhead to always specify a control vector register. The second form with element is the broadcast mode where a selected element of one vector instruction operates across all elements of the second source vector register. The form with VRs-3 is the general vector mapping mode form, where any two elements of two source vector registers could be paired. The word “mapping” in mathematics means “A rule of correspondence established between sets that associates each element of a set with an element in the same or another set”. The word mapping herein is used to mean establishing an association between a said vector element position and a source vector element and routing the associated source vector element to said vector element position.

All SIMD vector instructions are conditional, i.e., their execution is based on a selected condition code flag. Optional CC represents the condition code selection, and it could be omitted if “always true” is to be selected. The selected condition from the opcode is compared to one or an aggregated set of condition flags from vector condition flag register that contains condition flags from prior vector operation for each vector element position. If the selected or aggregated condition flag for a given vector element position is not true, then the results of operation for that respective vector element position is not stored into destination vector register. However, vector operation still takes place, for example vector-multiply-accumulate (VMAC) still updates the vector accumulator even though destination vector register VRd is not written.

For example: VADD.T VR3, VR1, VR2, VR15;
As an example, let us assume we have 16 vector elements, and 16 bits for each element. Let us further assume that control fields of the vector control register for each element are defined as follows, in a given embodiment:

Bits 4-0: Select source element from S-1 vector register;

Bits 9-5: Select source element from S-2 vector register;

Bit 15: Mask bit, when set to one disables writing the output of the execution unit to the destination vector register, for that element.

The condition code select field is common to all vector elements, and is defined as part of an opcode extension. Table 1 gives an example of the condition codes that could be used.

TABLE 1
Example Condition Codes for Vector Instructions.

| | | Signed/ |
|---|---|---|
| Condition | Test | Unsigned |
| False | 0 | Both |
| Carry Clear | !C | Unsigned |
| (Lower) | | |
| Carry Set | C | Unsigned |
| (Higher or Same) | | |
| Equal | Z | Both |
| Greater or Equal | (N&V) + (!N&!V) | Signed |
| Greater Than | (N&V&Z) + | Signed |
| | (!N&!V&!Z) | |
| Higher Than | C&!Z | Unsigned |
| Less or Equal | Z + (N&!V) + | Signed |
| | (!N&V) | |
| Lower or Same | !C + Z | Unsigned |
| Less Than | (N&!V) + (!N&V) | Signed |
| Minus | N | Signed |
| Not Equal | !Z | Both |
| Plus | !N | Signed |
| True | 1 | Both |
| Overflow Clear | !V | Signed |
| Overflow Set | V | Signed |

The embodiment of Table 1 shows multiple condition flags. It is also possible to test for an aggregated condition such as greater-or-equal and set a single condition flag. This way each vector element position of a vector condition flag (VCF) register at 370 of FIG. 3 could have multiple aggregated condition flags to select from. Preferred embodiment uses a VCF that is as wide as the vector register, for example, 256-bits, or 16-bits for each vector element and 16 vector elements. Two of these conditions could be hard-wired as true and false, and the other 14 could be selectively set by vector compare or test instruction. Such an instruction will set one of the condition flags for each vector element position. A conditional vector instruction selects one of these flags for each vector position and uses it for enabling or disabling that vector position, assuming that the disable (mask) bit is set to zero.

Example vector arithmetic operation instructions are shown in table below:

| Assembly Syntax | | Description |
|---|---|---|
| VABS.[cond] | VRd, VRs, VRs-3 | Absolute Value: |
| VABS.[cond] | VRd, VRs | VRd ← abs (VRs) |
| VADD.[cond] | VRd, VRs-1, VRs-2, VRs-3 | Addition: |
| VADD.[cond] | VRd, VRs-1, VRs-2 [element] | VACC ← VRs-1 + VRs-2 |
| VADD.[cond] | VRd, VRs-1, VRs-2 | VRd ← Signed-Clamp (VACC) |
| VADDS.[cond] | VRd, VRs-1, VRs-2, VRs-3 | Addition Scaled: |
| VADDS.[cond] | VRd, VRs-1, VRs-2 [element] | VACC ← (VRs-1 + VRs-2) 2 |
| VADDS.[cond] | VRd, VRs-1, VRs-2 | VRd ← Signed-Clamp (VACC) |
| VSUB.[cond] | VRd, VRs-1, VRs-2, VRs-3 | Subtraction: |
| VSUB.[cond] | VRd, VRs-1, VRs-2 [element] | VACC ← VRs1 − VRs-2 |
| VSUB.[cond] | VRd, VRs-1, VRs-2 | VRd ← Signed-Clamp (VACC) |
| VMUL.[cond] | VRd, VRs-1, VRs-2, VRs-3 | Multiply: |
| VMUL.[cond] | VRd, VRs-1, VRs-2 [element] | VACC ← VRs-1 * VRs-2 |
| VMUL.[cond] | VRd, VRs-1, VRs-2 | VRd ← Signed-Clamp (VACC) |
| VABSD.[cond] | VRd, VRs-1, VRs-2, VRs-3 | Absolute Difference: |
| VABSD.[cond] | VRd, VRs-1, VRs-2 [element] | VACC ← abs (VRs-1 − VRs-2) |
| VABSD.[cond] | VRd, VRs-1, VRs-2 | VRd ← Signed-Clamp (VACC) |

Vector-Accumulate Instructions: Results Affect Accumulator and Destination Vector Register.

| | | |
|---|---|---|
| VSAD.[cond] | VRd, VRs-1, VRs-2, VRs-3 | Sum-of-Absolute-Differences: |
| VSAD.[cond] | VRd, VRs-1, VRs-2 | VACC ← VACC + abs (VRs-1 − VRs-2) |
| | | VRd ← Signed-Clamp (VACC) |
| VADDA.[cond] | VRd, VRs-1, VRs-2, VRs-3 | Add-Accumulate: |
| VADDA.[cond] | VRd, VRs-1, VRs-2 [element] | VACC ← VACC + (VRs-1 + VRs-2) |
| VADDA.[cond] | VRd, VRs-1, VRs-2 | VRd ← Signed-Clamp (VACC) |
| VSUBA.[cond] | VRd, VRs-1, VRs-2, VRs-3 | Subtract-Accumulate: |
| VSUBA.[cond] | VRd, VRs-1, VRs-2 | VACC ← VACC + (VRs-1 − VRs-2) |
| | | VRd ← Signed-Clamp (VACC) |
| VMAC.[cond] | VRd, VRs-1, VRs-2, VRs-3 | Multiply-Accumulate: |
| VMAC.[cond] | VRd, VRs-1, VRs-2 [element] | VACC ← VACC + (VRs-1 * VRs-2) |
| VMAC.[cond] | VRd, VRs-1, VRs-2 | VRd ← Signed-Clamp (VACC) |
| VSAC.[cond] | VRd, VRs-1, VRs-2, VRs-3 | Multiply-Subtract-Accumulate: |
| VSAC.[cond] | VRd, VRs-1, VRs-2 [element] | VACC ← VACC − abs (VRs-1 * VRs-2) |
| VSAC.[cond] | VRd, VRs-1, VRs-2 | VRd ← Signed-Clamp (VACC) |

VACC: Vector Accumulator

As an example, let us look at a vector-multiply operation for video blending, where each pixel has four components: red, green, blue, and alpha. Let us assume that we want to multiply each pixel with its alpha value, before adding multiple pixels together. We want to affect only the red, green, and blue components while leaving the alpha values unchanged. In this case, both source vectors are the same, and we have:

VMUL.T VR3, VR1, VR1, VR4

VMAC.T VR3, VR2, VR2, VR4

Where VR4 is a vector register functioning as the control vector register with contents: VR4={0x03, 0x23, 0x43, D, 0x87, 0xA7, 0xC7, D, 0x10B, 0x12B, 0x14B, D, . . . } where “0x” indicates hex number format and the constant value used to disable is D=0x8000, per the above definition of control fields. The numbers above show pairing of elements [0,3], [1,3], [2,3], [4,7], [5,7], [6,7], [8,11], [9,11], [10,11], and so forth, where we assume the vector elements are numbered left to right respectively for 0 through 15, as shown in FIGS. 2 and 3.
The first vector instruction, vector multiply (VMUL), multiplies two input vector registers VR1 and VR1, where elements 0 through 2 are multiplied with element 3, elements 4 through 6 are multiplied with element 7, and so forth. We interpret the contents of a source vector register as {Red, Green, Blue, Alpha} starting with element zero, which contains the red component. The results are written both to the accumulator and the output vector register VR3. The condition code flag, specified as “.T” indicates true, in other words, condition codes are not used for this operation. In such a case, “.T” could be omitted for better readability. The second vector instruction performs a vector multiply-accumulate operation, adding to the results of the first vector instruction using the same mapping control register VR4.

In a different embodiment, we use an alternate vector register file to contain control vector elements. Alternate vector register file is a different vector register file than the primary vector register file but with the same size per element and number of elements per vector, and since it sources only a single source operand, it has only one read port. Sometimes vector register resources are scarce and allocating some of these for control reduces these and adds another port to this multi-ported register file. Also, certain vector operations require read-only source operands, and for these an alternate register file with a single read port for vector operations fits best, as these alternate vector registers are never used as a destination for vector arithmetic instructions.

The operation for each vector position may also be selected individually, and that selection is defined by a control field for each vector position. For example, we may specify the control vector fields for each vector control element as follows:

Bits 4-0: Select source element from S-1 vector register;

Bits 9-5: Select source element from S-2 vector register;

Bits 12-10: Define operation, e.g., multiply, add, logical AND, etc.

Bit 15: Mask bit, when set to a value of one, it disables writing output for that element.

This method uses existing hardware, because each vector position already contains a general processing element that performs arithmetic and logical operations. The advantage of this is in implementing mixed operations where certain elements are added and others are multiplied, for example, as in a fast DCT implementation. We could call the Vector Operation (VOP) where the vector control register defines operations as follows:

VOP.CC VRd, VRs-1, VRs-2, VRs-3

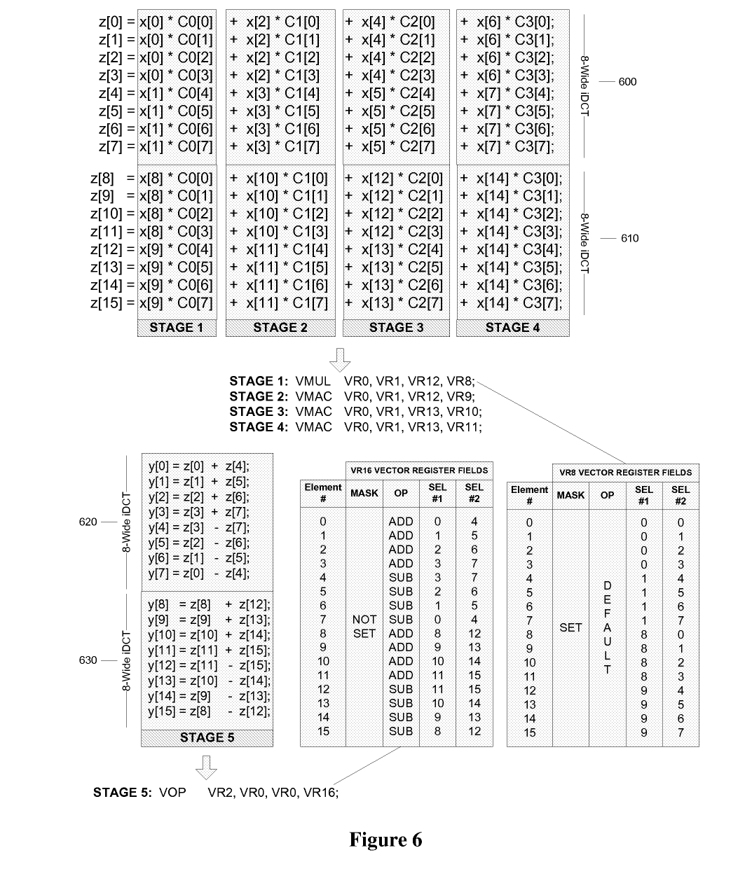

FIG. 6 shows an example implementation of 8-element inverse DCT used by MPEG standards for video decoding, which is used by DVDs to terrestrial TV reception of MPEG transport stream data. There are numerous DCT algorithms available. One such inverse DCT algorithm can be found in reference: A Fast precise Implementation of 8×8 Discrete Cosine Transform Using the Streaming SIMD Extensions and MMX Instructions, Version 1.0, 4/99, Intel AP-922, Order Number 742474-001. Assuming we use 16-wide embodiment of the present invention. We would load two input vectors into VR1, and preload packed vector constants into vector registers VR12 as follows:

VR1={x[0], x[1], x[2], x[3], x[4]; x[5], x[6], x[7], x[8], x[9], x[10], x[11], x[12]; x[13], x[14], x[15]} which is actually two 8-length input vectors put into the same vector register.
VR12={C0[0], C0[1], C0[2], C0[3], C0[4], C0[5], C0[6], C0[7], C1[0], C1[1], C1[2], C1[3], C1[4], C1[5], C1[6], C1[7]} which contains two rows of constants and similarly VR13 contains the remaining two rows of constants. Each stage of calculation works on two partial results of 8-length iDCT: 600 and 610 for stages 1-4, and 620 and 630 for stage 5.
The stage-1 use a vector multiply (VMUL) instruction which load the vector accumulator with the first partial result. The subsequent three vector-multiply-accumulate (VMAC) instructions performs vector multiply and adds the results to the vector accumulator for stages 2-4. The vector accumulator is scaled and written to vector output register VR0, but since the results of Stages 1-3 are not important, only the VR0 from stage 4 carries results we could use in stage 5. In this example, we masked the VR0 output for Stages 1-3 in order to reduce power consumption since such writes in a data-crunching intensive inner loop consumes power, but interim result in VR0 is not needed (partial result is stored in vector accumulator). All five stages require mapping of both source vectors and stage 5 also requires different operations (add or subtract). This shows that calculation of 8-length inverse DCT is performed in five vector instructions, but since this produces results for two 8-length iDCTs, the performance is 2.5 vector instructions per 8-length iDCT.

1.-44. (canceled)

45. An execution unit for use in a computer system for operably pairing elements of two vector operands based on a user-defined mapping and carrying out a vector operation defined in a computer instruction on said paired elements, the execution unit comprising:
first and second input vector registers for holding respective first and second source vector operands on which said vector operation is to be carried out, wherein each of said first and second input vector registers holds a plurality of vector elements of a predetermined size, each of said plurality of vector elements defining one of a plurality of vector element positions;
at least one control vector register;
means for loading said first and second input vector registers, and said at least one control vector register;
a plurality of operators associated respectively with said plurality of vector element positions for carrying out said vector operation;
means for selecting and pairing any element of said first input vector register with any element of said second input vector register as inputs to said plurality of operators for each vector element position in dependence on said at least one control vector register; and
a destination vector register for holding results of said vector operation on an element-by-element basis.

46. The execution unit according to claim 45, wherein part of said at least one control vector register provide means to also control the selection of one operation from a plurality of operations for each vector element position.

47. The execution unit according to claim 45, wherein said first and second input vector registers, said destination vector register and said at least one control vector register are part of a vector register file including a plurality of vector registers with a plurality of read data ports and at least one write data port, whereby elements of said plurality of vector registers are accessed in parallel.

48. The execution unit according to claim 45, wherein means for determining independently for each element position whether or not results of said vector operation are to be written into said destination vector register for that element position in dependence on user-defined mask bits as part of said at least one control vector register and at least one condition flag value derived from results of executing a prior instruction sequence.

49. The execution unit according to claim 45, wherein said at least one control vector register is specified as a third source vector operand of said computer instruction.

50. The execution unit according to claim 45, wherein three vector instruction formats are supported in pairing elements of said first and second source vector operands: respective element-to-element format as default, one-element broadcast format, and any-element-to-any-element format requiring a third source vector operand.

51. An apparatus for mapping first and second source vector elements, in accordance with a control vector, and performing arithmetic or logical operations on said mapped first and second source vector elements in parallel, the apparatus comprising:
a vector register file including a plurality of vector registers with a plurality of read data ports and at least one write data port, wherein said first source vector, said second source vector and said control vector can be accessed in parallel;
addresses for said plurality of read data ports and said at least one write port are coupled to respective source and destination fields of a vector instruction;
a first select logic coupled to a respective read port for said first source vector for mapping said first source vector elements in accordance with said control vector;
a second select logic coupled to a respective read port for said second source vector for mapping said second source vector elements in accordance with said control vector;
a vector operation unit including a plurality of computing elements coupled to outputs of said first select logic and said second select logic for performing said arithmetic or logical operations on vector elements in parallel as defined by said vector instruction; and
means for storing the output of said vector operation unit in a destination vector register in said vector register file.

52. The apparatus of claim 51, wherein a different arithmetic or logical operation can be chosen for each vector element position of said vector operation unit in accordance with said control vector.

53. The apparatus of claim 51, further including:
a register for storing vector condition flags including a plurality of condition flags per each vector element position; and
an enable logic coupled to said at least one write port of said vector register file for controlling storing elements of said destination vector register in said vector register file on an element-by-element basis in accordance with respective mask bits of said control vector and at least one of said plurality of condition flags derived from results of previous vector instructions.

54. The apparatus of claim 53, wherein one of said plurality of condition flags is hard wired to always true for each respective element position.

55. A method for flexibly pairing vector elements of a first source vector and a second source vector, in accordance with a third source vector as a control vector, and performing a vector operation, the method comprising:
storing said first source vector;
storing said second source vector;
storing said control vector;
selecting, in accordance with a first designated field of each vector element of said control vector, one of the vector elements of said first source vector;
selecting, in accordance with a second designated field of each vector element of said control vector, one of the vector elements of said second source vector;
performing said vector operation on respective vector elements of said selected first source vector and said selected second source vector to produce respective resulting elements of an output vector; and
storing said output vector, said output vector being the same size as said first source vector and said second source vector.

56. The method of claim 55, wherein a different computation from a multitude of operations that are available for each vector element position is selected for each vector element of said vector operation in accordance with respective elements of said control vector.

57. The method of claim 55 further comprising:
storing a condition flag vector derived from results of prior operations;
selecting at least one of a plurality of condition flags for each respective vector element in accordance with a vector instruction; and
enabling storing element of said output vector if a respective mask bit of said stored control vector is false and in accordance with said selected at least one of plurality of condition flags of a respective vector element.

58. The method of claim 57, wherein one of said plurality of condition flags for each respective vector element is defined as always true.

59. The method of claim 55, wherein each vector element contains a fixed-point number or a floating-point number, and the number of vector elements in each of said first source vector and said second source vectoris an integer between 8 and 256.
